(19) United States
(12) Patent Application Publication
(10) Pub. No.: US 2004/0002898 A1
(43) Pub. Date: Jan. 1, 2004

(54) Product order optimization in real time based on component information

(75) Inventors: Charles Edward Kuhlmann, Raleigh, NC (US); Francis E. Noel JR., Durham, NC (US); Ann Marie Rincon, Burlington, VT (US); Norman Clark Strole, Raleigh, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 10/064,289

(22) Filed: Jun. 28, 2002

(51) Int. Cl. G06F 17/60

(52) U.S. Cl. 705/26

(57) ABSTRACT

A system, method and program product for optimizing a product order in real time where the product includes at least one customer-selectable component. Component information such as component cost, delivery lag time and availability are determined in real-time by querying a manufacturer system and, in response to a component being unavailable at the manufacturer, querying at least one supplier system that can supply the component to the manufacturer. The customer is then offered at least one order option in real time based on the results of the determination.

### TECHNICAL FIELD

The present invention relates generally to product ordering and, more particularly, to product order optimization in real time based on component information.

### RELATED ART

Purchasing products over a computer network such as the Internet is a common activity, and practically every product known can now be purchased over such networks. In many instances, a manufacturer provides a build-to-order service, e.g., via a Web site, over the network through which the customer can create a product order. Practically every manufacturer offers their customers as many component options as practicable so that the actual product can be customized. In some cases, a component's manufacturer, i.e., its supplier to the product manufacturer, is unknown to the customer. In other cases, a unique component of a specific supplier may be selected.

Conventional product manufacturer system's do not allow a customer to optimize their order in real time relative to information about the component(s) that effects the order. Component information may include costs, lead time for delivery to the manufacturer, possibility of equivalent options, etc. Component information can be effected by the manufacturer and/or supplier in a number of ways. One situation that may affect component information is the common use of a virtual warehousing arrangement. Under a virtual warehousing arrangement, a manufacturer retains a number of suppliers who maintain much of the necessary component inventory for rapid shipment to the manufacturer. This allows the manufacturer to offer a wide range of products and component options but maintain a low inventory of components pending customer demand. The manufacturer may also keep a limited inventory of the various components necessary so a certain number of products can be prepared without placing an order with a supplier.

Each supplier may have a different position relative to component information that they control, e.g., component availability, cost, and/or lead time for delivery to the manufacturer. Conventionally, the customer is never informed of this information, which may effect, for example, overall product delivery date and/or costs. If the customer was informed in real time that a particular component would delay delivery, he/she may wish to change the order. In addition, in some circumstances, alternative components that provide similar advantages as those sought by the customer at lower costs or quicker delivery are not offered to the customer in real time. The above situation leads to a situation where the customer's product order is not fully optimized because component information is not adequately utilized.

In view of the foregoing, there is a need in the art for product order optimization in real time based on component information.

### SUMMARY OF THE INVENTION

Product order optimization is provided by offering customers options relative to components in real time based component information. The options offered may affect delivery time, costs, etc., and allow the customer to optimize the product order to their liking.

A first aspect of the invention is directed to a method of optimizing a product order where the product includes at least one customer-selectable component, the method comprising the steps of: receiving the product order; determining component information in real-time by querying a manufacturer system and, in response to a component being unavailable at the manufacturer, querying at least one supplier system in real time that can supply the component to the manufacturer; and offering the customer at least one order option in real time based on a result of the determination.

A second aspect of the invention is directed to a computer program product comprising a computer useable medium having computer readable program code embodied therein for optimizing a product order where the product includes at least one customer-selectable component, the program product comprising: program code configured to receive the product order; program code configured to determine component information in real-time by querying a manufacturer system and, in response to a component being unavailable at the manufacturer, querying at least one supplier system in real time that can supply the component to the manufacturer; and program code configured to offer the customer at least one order option in real time based on a result of the determination.

A third aspect of the invention is directed to a system for optimizing a product order where the product includes at least one customer-selectable component, the system comprising: a customer interface module that provides a customer with a menu of component options and allows the customer to make a selection from the menu; a component information determinator that determines, in real-time, at least one of component cost, component delivery lag time, component availability, and product delivery lag time and cost for different manufacturing sites by querying a manufacturer system and, in response to a component being unavailable at the manufacturer, querying at least one supplier system that can supply the component; and an options generator that offers the customer at least one order option in real time based on a result of the determination.

The foregoing and other features of the invention will be apparent from the following more particular description of embodiments of the invention.

### BRIEF DESCRIPTION OF THE DRAWINGS

The embodiments of this invention will be described in detail, with reference to the following figures, wherein like designations denote like elements, and wherein:

FIG. 1 shows an exemplary computer network product order environment;

FIG. 2 shows a manufacturer system implementing product order optimization;

FIG. 3 shows a flow diagram of the process of product order optimization;

FIG. 4 shows an exemplary computer system product purchase order interface; and

FIG. 5 shows an exemplary options offered to a customer.

### DETAILED DESCRIPTION

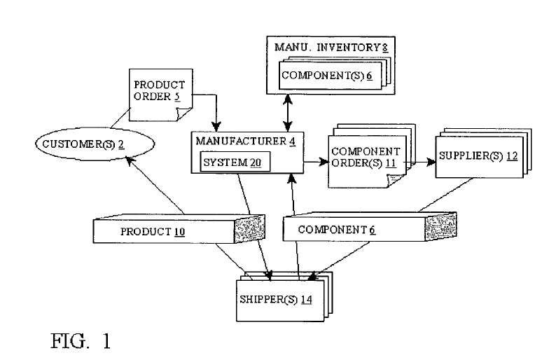

With reference to the accompanying drawings, FIG. 1 shows an exemplary environment in which the invention is practicable. In this exemplary setting, a customer 2 uses his/her computer system to communicate with a manufacturer 4 to place a product order 5 over a network such as the Internet. “Product” as used herein may include good(s), service(s) or any other commodity now known or later developed. “Component” as used herein shall refer to any commodity now known or later developed that could provide at least a part of overall product 10. One exemplary product in which the invention finds advantage is personal computer systems.

Manufacturer 4 provides a build-to-order service by which a product 10 is built to a specific order. Customer 2 can select from a menu of options to create a customized product. Manufacturer 4 may keep a limited supply of components 6 in manufacturer inventory 8 so a certain number of products 10 can be prepared, or may place component order(s) 11, as needed, to one or more supplier(s) 12. Suppliers 12 are expected to maintain an inventory of components (not shown) for rapid shipment via a shipper(s) 14 to manufacturer 4. This arrangement is especially advantageous where manufacturer 4 wants to offer a wide range of options but maintain a low inventory of components pending customer demand.

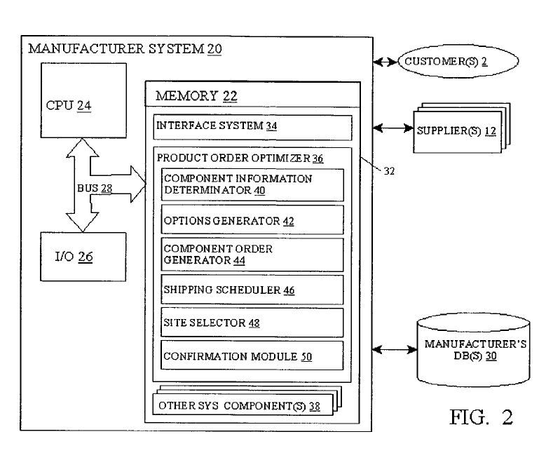

FIG. 2 is a block diagram of a manufacturer system 20, which in conjunction with customer(s) 2 and supplier(s) 12 systems, implements product order optimization according to the invention. Manufacturer system 20 includes a memory 22, a central processing unit (CPU) 24, input/output devices (I/O) 26 and a bus 28. A manufacturer's database(s) 30 may also be provided for storage of data relative to processing tasks. Database(s) 30 may include, for example, an inventory database, a customer database, and any other well known database generally used in a manufacturer system 20. Memory 22 includes a program product 32 that, when executed by CPU 24, comprises various functional capabilities described in further detail below.

Memory 22 (and database 30) may comprise any known type of data storage system and/or transmission media, including magnetic media, optical media, random access memory (RAM), read only memory (ROM), a data object, etc. Moreover, memory 22 (and database 30) may reside at a single physical location comprising one or more types of data storage, or be distributed across a plurality of physical systems. CPU 24 may likewise comprise a single processing unit, or a plurality of processing units distributed across one or more locations. A server computer typically comprises an advanced mid-range multiprocessor-based server, such as the RS6000 from IBM, utilizing standard operating system software, which is designed to drive the operation of the particular hardware and which is compatible with other system components and I/O controllers. I/O 26 may comprise any known type of input/output device including, for example, a network system, modem, keyboard, mouse, scanner, voice recognition system, CRT, printer, disc drives, etc. Additional components, such as cache memory, communication systems, system software, etc., may also be incorporated into system 20.

As shown in FIG. 2, program product 32 may include an interface system 34, a product order optimizer 36 and other system components 38. Interface system 34 functions to interface with any system that must communicate with system 20, e.g., customer 2 and supplier(s) 12. Product order optimizer 36 functions to provide the processes according to the invention. Other system components 38 may include any other well known manufacturer system 20 components such as an inventory tracking system, a product catalog system, a customer tracking database, a financial sub-system, etc.

Product order optimizer 36 may include, inter alia, a component information determinator 40, an options generator 42, a component order generator 44, a shipping scheduler 46, a site selector 48, and a confirmation module 50. The function of each of the above-identified parts will be described in detail in the process description that follows. It should be recognized that program product 32 has been compartmentalized in a fashion for readily describing the invention. The teachings of the invention, however, should not be limited to any particular organization, and functions illustrated as being part of any particular system, module, etc., may be provided via other systems, modules, etc.

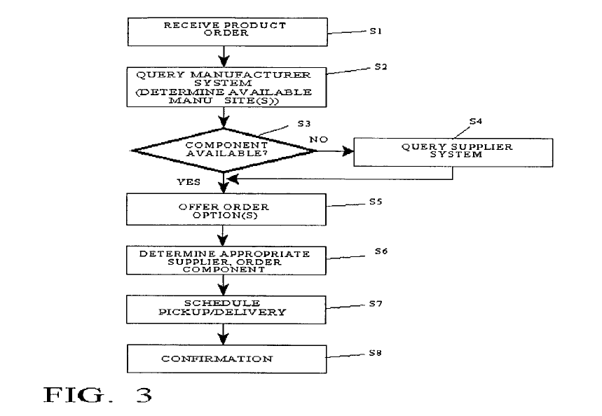

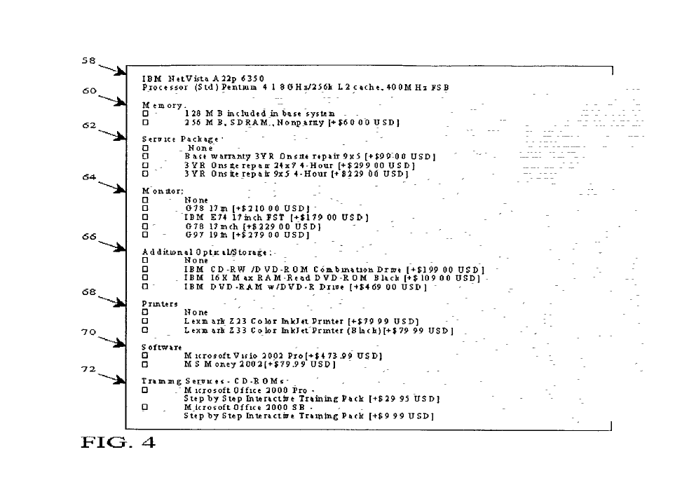

Referring to FIG. 3, a flow diagram illustrating the process of product order optimization and other advantages of the invention is provided. In a first step S1, a product order is received by manufacturer system 20 (FIG. 2). The product order may include any information necessary to respond to the order such as product/components order, customer information such as name, customer ship-to location, payment method, etc. Customer 2 may be provided with a menu of options in a known fashion. In one embodiment, manufacturer system 20 may provide a Web site via interface system 34 that customer 2 may access over the Internet to generate a product order. An exemplary Web site 58 for computer equipment is shown in FIG. 4. In terms of a Web site for purchasing computer equipment, options may be for any now known or later developed piece of computer equipment. As shown in FIG. 4, a non-exhaustive list of component options for a personal computer system may include: memory 60, a service package 62, a monitor 64, additional optical/storage 66, a printer 68, software 70, training services 72, etc.

In steps S2-S4, component information determinator 40 of product order optimizer 36 determines component information in real time. Component information may include, inter alia: component availability, component cost, component delivery lag time to the manufacturer if the component is only available from a supplier, product delivery lag time and cost for different manufacturing sites, or any other relevant information relative to a component. The determination may occur for every component required to complete the product, only components selectable by the customer, or any other arrangement the manufacturer wishes to provide. It should be recognized that while steps S2-S4 are shown in a particular order, some tasks may be completed in a different order or simultaneously.

Determinator 40 begins, at step S2, by querying manufacturer system 20 in real-time. The query accesses whatever parts of manufacturer system 20, e.g., inventory database 30, is necessary to determine the component information. In some situations a manufacturer 4 (FIG. 1) may have a number of manufacturing sites. In this case, each manufacturing site may be queried or at least one available manufacturing site may determined and then queried. The at least one available manufacturing site may be determined based on at least one site factor such as: cost (e.g., shipment of component and/or product, export/import taxes, export/import tariffs, etc.), component(s) selected, proximity of a required supplier (step 54) to a manufacturing site (ship-from) and related delivery lag time, proximity of a manufacturing site to a customer ship-to location and related delivery lag time, existing component inventory at a manufacturing site, a manufacturing site capacity, and other factors. As will be understood from the following description, where more than one available manufacturing site exists, customer 2 may select which is optimal.

If it is determined, in step S3, that a component necessary to fulfill the order is unavailable at the manufacturer (i.e., the manufacturer as a whole or at an available manufacturing site(s)), at least one supplier 12 that can fulfill an order for the unavailable component is also queried in real time at step S4. The supplier(s) that is queried may be determined based on the available manufacturing site(s) ascertained at step S2, e.g., a supplier that is closest to the available manufacturing site may be queried. The query accesses whatever parts of a supplier system, e.g., an inventory database, is necessary to determine the component information. There are a variety of ways in which this task can be carried out in real time. A couple of possibilities are: manufacturer system 20 periodically (e.g., once a day, per hour, etc.) downloads an inventory database and any other required information from a supplier 12, or manufacturer system 20 is linked via interface system 34 to supplier system.

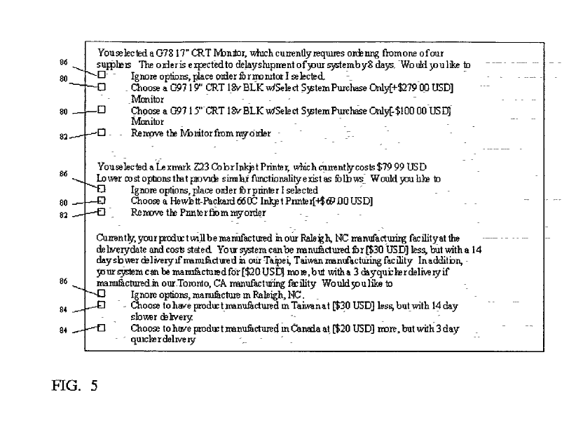

In step S5, options generator 42 of product order optimizer 36 generates and offers customer 2 at least one order option in real time based on a result of the determination in steps S2-54. Where a Web site is the communications mechanism used, options generator 42 may offer options as shown in FIG. 5. Options may include at least one of, for example, offering the customer an alternate component 80, removing a component from the order 82, selecting a manufacturing site 84, or ignoring the at least one option 86. The basis upon which an option is provided is user defined. For example, if product delivery is going to be delayed because a component cannot be delivered within a set time frame, options generator 42 may offer an alternate component. In another example, where a lower cost component is available, options generator 42 may offer that component to customer 2. In yet another example, where more than one available manufacturing site is determined in step S2, options generator 42 may create options based on the available manufacturing sites. For instance, if a product 10 is less expensive to manufacture at a manufacturing site in a foreign country compared to a domestic site, but delivery will be delayed, options generator 42 may offer the customer 2 a choice between manufacturing sites 84, and perhaps their related costs and delivery times. Further information regarding each option may be provided in any known fashion such as hypertext links.

Steps S6-S8 represent alternative processing. In step S6, once customer 2 makes his/her final selections, a component order generator 44 of product order optimizer 36 may determine an appropriate supplier that can fulfill an order for the unavailable component, and place an order 11 (FIG. 1) for the unavailable component with the appropriate supplier system. This function is applied where more than one supplier can fulfill component order 11. The basis for which a supplier is an appropriate supplier can be user defined. For example, an appropriate supplier may be based on lowest cost, minimum delivery lag time, or other factors.

In step S7, scheduling of at least one of a product delivery schedule and a component delivery schedule with a shipper system is conducted by shipping scheduler 46. Scheduler 46 may schedule pickup and delivery, and inform the relevant parties on product delivery dates.

Another alternative step, step S8, is to provide confirmation of at least one of customer product fulfillment conditions (e.g., price, ship date, etc.), supplier order and ship information, shipper scheduling, and other logistical information using a confirmation module 50.

In the previous discussion, it will be understood that the method steps discussed are performed by a processor, such as CPU 24 of system 20, executing instructions of program product 32 stored in memory. It is understood that the various devices, modules, mechanisms and systems described herein may be realized in hardware, software, or a combination of hardware and software, and may be compartmentalized other than as shown. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after the following: (a) conversion to another language, code or notation; and/or (b) reproduction in a different material form.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention as defined in the following claims.

1. A method of optimizing a product order where the product includes at least one customer-selectable component, the method comprising the steps of:
receiving the product order;
determining component information in real-time by querying a manufacturer system and, in response to a component being unavailable at the manufacturer, querying at least one supplier system in real time that can supply the component to the manufacturer; and
offering the customer at least one order option in real time based on a result of the determination.

2. The method of claim 1, wherein the component information includes at least one of: component availability, component cost, component delivery lag time to the manufacturer if the component is only available from a supplier, and product delivery lag time and cost for different manufacturing sites.

3. The method of claim 1, wherein the at least one option is selected from the group comprising: offering the customer an alternate component, removing a component from the order, selecting a manufacturing site, and ignoring the at least one option.

4. The method of claim 1, further comprising determining an appropriate supplier that can fulfill an order for a component that is unavailable at the manufacturer, and placing an order for the unavailable component with a system of the appropriate supplier.

5. The method of claim 1, further comprising the step of scheduling at least one of a product delivery schedule and a component delivery schedule with a shipper system.

6. The method of claim 1, further comprising the step of determining an available manufacturing site based on at least one site factor.

7. The method of claim 6, wherein the at least one site factor is selected from the group comprising: cost, component selected, proximity of a required supplier to a manufacturing site, proximity of a manufacturing site to a customer ship-to location, a manufacturing site capacity, and existing component inventory at a manufacturing site.

8. The method of claim 7, further comprising the step of confirming at least one of customer product fulfillment conditions, supplier order and ship information, and shipper scheduling.

9. A computer program product comprising a computer useable medium having computer readable program code embodied therein for optimizing a product order where the product includes at least one customer-selectable component, the program product comprising:
program code configured to receive the product order;
program code configured to determine component information in real-time by querying a manufacturer system and, in response to a component being unavailable at the manufacturer, querying at least one supplier system in real time that can supply the component to the manufacturer; and
program code configured to offer the customer at least one order option in real time based on a result of the determination.

10. The program product of claim 9, wherein the component information includes at least one of: component availability, component cost, component delivery lag time to the manufacturer if the component is only available from a supplier, and product delivery lag time and cost for different manufacturing sites.

11. The program product of claim 9, wherein the at least one option is selected from the group comprising: offering the customer an alternate component, removing a component from the order, selecting a manufacturing site, and ignoring the at least one option.

12. The program product of claim 9, further comprising program code configured to
determine an appropriate supplier that can fulfill an order for a component that is unavailable at the manufacturer, and place an order for the unavailable component with a system of the appropriate supplier.

13. The program product of claim 9, further comprising program code configured to schedule at least one of a product delivery schedule and a component delivery schedule with a shipper system.

14. The program product of claim 9, further comprising program code configured to determine at least one available manufacturing site based on at least one site factor.

15. The program product of claim 14, wherein the at least one site factor is selected from the group comprising: cost, a component selected, proximity of a required supplier to a manufacturing site, proximity of a manufacturing site to a customer ship-to location, a manufacturing site capacity, and existing component inventory at a manufacturing site.

16. The program product of claim 15, further comprising program code configured to confirm at least one of customer product fulfillment conditions, supplier order and ship information, and shipper scheduling.

17. A system for optimizing a product order where the product includes at least one customer-selectable component, the system comprising:
a customer interface module that provides a customer with a menu of component options and allows the customer to make a selection from the menu;
a component information determinator that determines, in real-time, at least one of component cost, component delivery lag time, component availability, and product delivery lag time and cost for different manufacturing sites by querying a manufacturer system and, in response to a component is unavailable at the manufacturer, querying at least one supplier system that can supply the component; and
an options generator that offers the customer at least one option in real time based on a result of the determination.

18. The system of claim 17, wherein the at least one option is selected from the group comprising: offering the customer an alternate component, removing a component from the order, selecting a manufacturing site, and ignoring the at least one option.

19. The system of claim 17, further comprising a component order generator that determine an appropriate supplier that can fulfill an order for a component that is unavailable at the manufacturer, and places an order for the unavailable component with a system of the appropriate supplier.

20. The system of claim 17, further comprising program code configured to schedule at least one of a product delivery schedule and a component delivery schedule with a shipper system.
